(19) United States
(12) Patent Application Publication
(10) Pub. No.: US 2007/0282643 A1
(43) Pub. Date: Dec. 6, 2007

(54) Management Diagnosis Report Preparation System

(75) Inventors: Nobutaka Okabe, Tokyo (JP); Masayuki Satou, Tokyo (JP); Ichirou Hayashi, Tokyo (JP); Hirofumi Kosaka, Tokyo (JP); Masaki Suzuki, Tokyo (JP); Satoko Sakurai, Tokyo (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Honda Motor Co., Ltd.

(21) Appl. No.: 10/594,058

(22) PCT Filed: Mar. 18, 2005
(86) PCT No.: PCT/JP05/05634

§ 371 Date: Jun. 18, 2007

(30) Foreign Application Priority Data
Mar. 30, 2004 (JP) 2004-100069
Mar. 30, 2004 (JP) 2004-100038

(51) Int. Cl. G06Q 90/00

(52) U.S. Cl. 705/7

(57) ABSTRACT

A management diagnosis report preparation system comprises a first memory for storing, check items for reviewing the achievement of each theme, an check result indication given to respective check items for indicating the check results by an acting department, actions for achieving the themes, and evaluation values indicating the degree of the effectiveness for the action, a second memory for storing past reports including the past themes and actions used for achieving the past themes and a computer for preparing a report. The computer is programmed to increase or decrease the evaluation values of the actions based on a comparison with the past reports, to select an action having a high evaluation value among all the actions related to the check items carrying the check result indication, and to prepare a current report including the selected action and a theme corresponding to a check item carrying the check result indication.

### TECHNICAL FIELD

The present invention relates to a system used to improve soundness of company activities, and in particular, relates to a system for preparing a report describing effective actions for achieving corporate themes.

### BACKGROUND ART

Troubles caused by unsound activities within a company adversely affect the social evaluation of the company, which in turn damages the stockholders of the company. With increase in investment of foreign capital in Japanese companies, the consciousness that a company is owned by the stockholders who provided the capital has been enhanced. This enlightenment has promoted strength of concept including corporate governance, compliance, risk management and corporate moral. Companies have thus come to take various actions to achieve sound corporate activities. These actions are administrated by means of documents and terminals in a company, and notified as required to each department and section to abide by.

Japanese Patent Application Publication No. 9-114801 discloses a system for an insurance sales department to quantitatively calculate, display and diagnose the risk of customer companies. Japanese Patent Application Publication No. 2003-99431, on the other hand, discloses a management diagnosis system for providing the user with information about a compliance manual for the requested department and for the requested year.

Japanese Patent Application Publication No. 2003-248752 discloses a management diagnosis system comprising a check sheet describing a plurality of check items for diagnosis and a policy-setting sheet for carrying out the management improvement activities based on diagnosis results.

### DISCLOSURE OF THE INVENTION

Recent corporate activities cover a great variety of fields. Further, Business fields of a company expand more and more as the size of the company enhances. Variety of activities and resulting expansion of the business increase the number of the laws for the company to abide by. Themes needing actions and actions to carry out sound corporate activities need to be prepared based on the laws. With the increase in the laws to abide by, therefore, the themes needing action and actions to be taken also increase. In such a situation, it has become difficult to select a theme needing action and an effective action for each business, or to selectively determine, according to priority, themes needing action and effective actions for each department within the company.

It is an object of the present invention to provide a system for preparing a report identifying corporate themes needing actions and effective actions to be taken. Such a report is prepared by evaluating actions for achieving corporate themes based on a check list verified by each business department. The invention also provides a system for preparing a report identifying corporate themes and effective actions to be taken, by collecting all the results of corporate-wide verification of the business undertaken by a department.

According to one aspect of the present invention, there is provided a management diagnosis report preparation system for preparing a report including actions for achieving the themes needing action. The system comprises a first memory for storing check items for reviewing achievement of each theme, check result indications given to respective check items for indicating the check results by an acting department, actions for achieving the themes, and evaluation values given to respective actions indicating the degree of effectiveness of respective actions. The system also comprises a second memory for storing the past reports including the past themes and the actions used for achieving the past themes. The system includes a computer for preparing a report, which computer is programmed to increase or decrease the evaluation values of the actions based on comparison with the past reports, to select an action having a high evaluation value among all the actions related to the check items carrying the check result indications, and to prepare a current report including a selected action and a theme corresponding to a check item carrying the check result indication.

In this way, the evaluation value of each action is increased or decreased based on the past reports. Therefore, an effective action can be selected based on the evaluation value of the action. Thus, a report including an effective action can be prepared.

According to another aspect of the present invention, there is provided a management diagnosis report preparation system, wherein the evaluation value is increased or decreased in such a manner that a theme included in the past reports is compared with a theme corresponding to a check item carrying a badness indication of the check result indications after the current review process has been done, and in the case where the theme is the same, the evaluation value of the actions for achieving the theme included in the past reports is decreased, or otherwise, the evaluation value of the actions for achieving the theme included in the past reports is increased. In this way, the evaluation value of the actions is increased or decreased based on the past reports. Therefore, an effective action can be selected and a report including the effective action can be prepared based on evaluation values of the actions.

According to yet another aspect of the present invention, the system further comprises a third memory for storing identification of an acting department that has reviewed the check items, and an input device for inputting the identification of an acting department, wherein the current report includes the themes corresponding to the check items reviewed by the acting department. In this embodiment of the present invention, the department for a report can be designated, and therefore, a report for the designated department is prepared.

According to yet another aspect of the invention, the second memory stores past badness values with respect to respective themes. The evaluation value is increased or decreased in such a manner that the badness value for a theme is determined based on the number of check result indications given to the check item in the current review, and is compared with corresponding past badness values, and when the current badness value is smaller than the past badness value, the evaluation value of the action for achieving the past theme is increased. On the other hand, when the current badness value is larger than the past badness value, the evaluation value of the action for achieving the past theme is decreased. In this aspect of the present invention, the evaluation value of an action is increased or decreased based on the past reports. Thus, an effective action can be selected based on the evaluation value, which is to be included in the current report.

According to a further aspect of the present invention, the system further comprises a third memory for storing an identification of a supervisory department for managing the check items and an input device for inputting the supervisory department. A current report includes those themes corresponding to the check items carrying a badness indication of the check result indications and corresponding to the check items managed by the supervisory department. In this aspect of the present invention, the supervisory department that manages the check items can be designated, and therefore, a report for a designated supervisory department can be prepared.

### BRIEF DESCRIPTION OF THE DRAWINGS

FIG. 1 is a diagram showing a system configuration of a management diagnosis report preparation system according to an embodiment of the present invention.

FIG. 2 is a flowchart showing the check list preparation process according to an embodiment of the present invention.

FIG. 3 is a flowchart showing the preparation process of the management diagnosis report according to an embodiment of the present invention.

FIG. 4 is a flowchart showing the preparation process of the management diagnosis report according to an embodiment of the present invention.

FIG. 5 is a diagram showing a superordinate concept and a subordinate concept of actions for check items according to an embodiment of the present invention.

FIG. 6 is a diagram showing an example of a report output according to an embodiment of the present invention.

### BEST MODE FOR CARRYING OUT THE INVENTION

1. System Configuration

A management diagnosis report preparation system according to an embodiment of the present invention will be explained below with reference to the drawings.

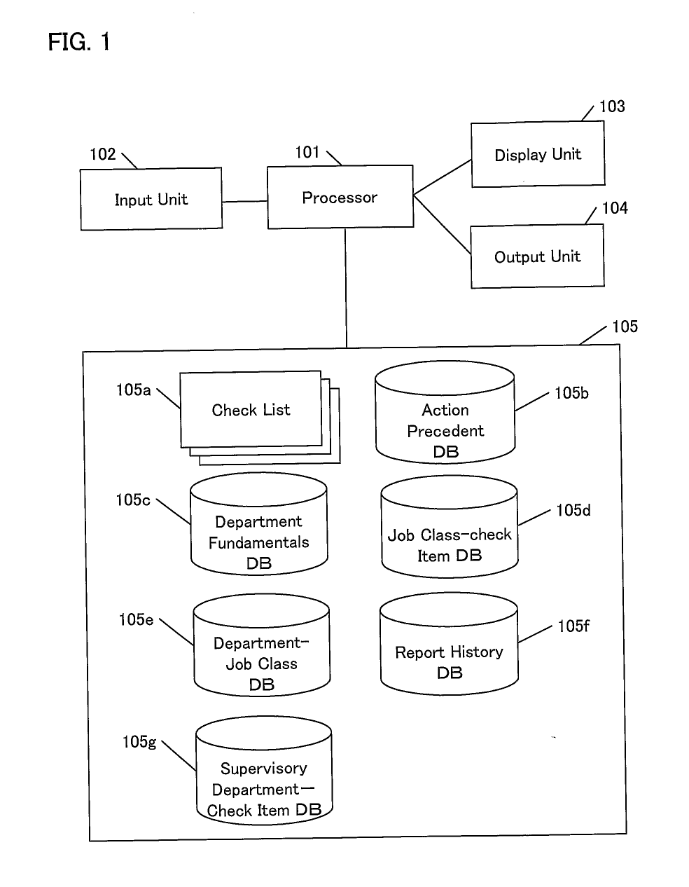

FIG. 1 shows a system configuration of a management diagnosis report preparation system according to one embodiment of the invention. The management diagnosis report preparation system according to this embodiment comprises a processor 101, an input unit 102, a display unit 103, an output unit 104 and a storage unit 105. These units are connected with the processor 101.

The processor 101 is a computer having a central processing unit (CPU), and a random access memory for temporarily storing data and programs. According to this embodiment, the processor 101 carries out the report preparation process and controls various databases. The input unit 102 is, for example, a keyboard and a mouse for entering data and handling the management diagnosis report preparation system. The input unit 102 is connected to the processor 101 through a serial interface.

The display unit 103 is, for example, an LCD (liquid crystal display) unit for displaying the output from the management diagnosis report preparation system. The display unit 103 communicates with the processor 101 via a graphic interface. The output unit 104 is, for example, a laser printer for printing reports output from the management diagnosis report preparation system. The output unit 104 is connected to the processor 101 through a parallel interface or a local area network (LAN).

A storage unit 105 is, for example, a hard disk for storing various data and provides a database for the management diagnosis report preparation system. The storage unit 105 stores software for implementing the databases and a program for executing a report preparation process described below. The databases used in this embodiment are relational databases. Additionally, the system according to this embodiment may include a plurality of storage units. The databases (DB) may be distributed among a plurality of storage units. According to this embodiment, a check list 105a, a action precedent DB 105b, a department fundamentals DB 105c, a job classification and check item DB 105d, a department and job classification DB 105e, a report history DB 105f, and a supervisory department and check item DB 105g are organized.

Table 1 shows an example of the data items (field names) of the department and job classification DB 105e.

TABLE 1

| Dept. | | Job | |
|---|---|---|---|
| code | Dept. name | class. | Job class. & description |
| 10-01 | Sales Div., Sales | A01 | Whole |
| | Dev. Section | S01 | (Domestic) new 4-wheeled car sales |
| | | | (Domestic) new motorcycle sales |
| | | S02 | (Domestic) general product sales |
| | | S03 | (Domestic) parts & supplies sales |
| | | | (Domestic) used products sales |
| | | S04 | (Domestic) Miscellaneous sales |
| | | | Admin. of regular employees |
| | | S05 | Admin. of non-regular employees |
| | | S06 | |
| | | M1 | |
| | | M2 | |
| 10-02 | Sales Div., Sales | A01 | Whole |
| | Dept. | S01 | (Domestic) new 4-wheeled car sales |
| | | | (Domestic) after-sale services |
| | | S11 | (Domestic) rental/lease |
| | | S21 | (Domestic) commercial credit business |
| | | S31 | (Domestic) sales agent support |
| | | S41 | (Domestic) products distribution |
| | | S42 | Admin. of regular employees |
| | | | Admin. of non-regular employees |
| | | M21 | |
| | | M22 | |
| . . . | . . . | . . . | . . . |

The department-job classification DB 105e is a database in which “job classification” is related to each “department”. According to the embodiment, the department and job classification DB 105e has “department code”, “department name”, “job classification” and “job classification & description” fields. Data are related to each other. The department code identifies a department in the company in the form of a numerical character. Each department is assigned a unique department code. “job classification” is a classification of the jobs in the company. Each job classification is assigned a unique job classification code. Each department is related to one or a plurality of job classifications. A job classification name may be associated with a plurality of departments. The “(domestic) new four-wheeled car sales”, for example, is associated with “Sales Divisions, Sales Development Section” and “Sales Divisions, Sales Department”.

Tables 2-1 and 2-2 jointly show an example of the data item names (field names) of the job classification and check item DB 105d.

TABLE 2-1

| Job | | | | | | |
|---|---|---|---|---|---|---|
| class. | Class. | | Middle | | | Laws/ |
| code | name | Area | item | Small item | Check item | ordinances |
| A01 | Whole | 2. | Securities | No unlawful | Have executives or | Securities |
| | | Compliance | Law | use of insider | employees having access to | Law |
| | | | | information? | sensitive info engaged in | |
| | | | | | stocks before announcement? | |
| | | | Labor | Application for | Has a resigning employee | Civil Law |
| | | | contracts | resignation | made to work against | Art. 627 |
| | | | | processed | his/her will for two or more | |
| | | | | properly? | weeks from the date of | |
| | | | | | resignation application? | |
| | | | Intellectual | Have acquired | Have acquired trade secrets | Unfair |
| | | | Property | trade secrets | of others by unlawful means | Competition |
| | | | | by unlawful | (stealing, fraud)? | Prevention |
| | | | | means? | | Law, Art. 2 |
| | | | | Have used | Have acquired or used trade | Unfair |
| | | | | trade secrets | secrets knowing that they | Competition |
| | | | | acquired by | have been acquired by | Prevention |
| | | | | unlawful | unlawful means? | Law, Art. |
| | | | | means? | | 2 |
| | | Risk | Risk in | Signature | Contracts signed or sealed | Civil Law, |
| | | management | transactions | and seal | by legitimate representative | Commercial |
| | | | and contracts | proper and | of the other party? | Law |
| | | | | correct? | | |
| | | | | Contract terms | Review by a lawyer or legal | |
| | | | | properly | dept. conducted when | |
| | | | | examined? | necessary? | |

TABLE 2-2

| Job | | | | | | |
|---|---|---|---|---|---|---|
| class. | Class. | | Middle | | | Laws/ |
| code | name | Area | item | Small item | Check item | ordinances |
| B01 | Domestic | 2. | Anti- | Specific | Disadvantageous | Antimonopoly |
| | and | Compliance | monopoly | company | transaction conditions | Law, Art. 19, |
| | overseas | | Law | discriminated | (payment conditions, | Specified |
| | purchase | | | unfairly? | etc.) applied to a | Unfair |
| | and | | | | company to exclude it? | Transaction |
| | acquisition | | | | | Method 3 |
| | | 2. | Anti- | Have | Have refused to | Antimonopoly |
| | | Compliance | monopoly | unreasonably | transact with specific | Law, Art. 19, |
| | | | Law | rejected a | company conducting | Unfair |
| | | | | transaction | cut-price business or | Tansaction |
| | | | | with a specific | intending new | Method in |
| | | | | company | participation to exclude | General, para. |
| | | | | solely or | them? Have not made | 1,2 |
| | | | | jointly with | arrangement with | |
| | | | | competitors? | competitors not to | |
| | | | | | transact with specific | |
| | | | | | company? | |
| S01 | (Domestic) | 2. | Laws on | Have | Have disclosed name, | Specific |
| | new | Compliance | Sales | disclosed | company name, types of | Commercial |
| | 4-wheeled | | Visit | company | commodity sold, right to | Transactions |
| | car sales | | | name and | sell and services to | Law, Art. 3 |
| | | | | commodity | customers at sales visit? | |
| | | | | type to | | |
| | | | | customers at | | |
| | | | | sales visit? | | |
| | | | Laws on | Have | Have immediately | Specific |
| | | | Sales | delivered | provided document | Commercial |
| | | | Visit | document | showing the specifics of | Transactions |
| | | | | showing | commodity when | Law, Art. 4 |
| | | | | specifics of | customer showed | |
| | | | | proposal? | interest in buying at | |
| | | | | | sales visit? | |
| . . . | . . . | . . . | . . . | . . . | . . . | . . . |

The job classification and check item DB 105d is a database which stores check items for each job classification. The job classification and check item DB 105d has the fields of “job classification code”, “classification name”, “area”, “middle item”, small item”, “check item” and “related laws/ordinances”. Data are related to each other, particularly in a horizontal direction in the tables.

The classification name is related to one or a plurality of “areas”. The “area” includes four areas of governance, compliance, risk management and corporate moral. Each area has one or a plurality of related middle items. The middle item is a name of laws and ordinances corresponding to a small item described below. The small item indicates an outline of the contents to be checked with a check item. The small item is related to a check item in one-to-one relation. The check item is a question to determine whether the contents described in a small item are applicable or not to check the achievement of a theme. Each check item is related to a name of laws or ordinances or a provision substantiating the check item. The “classification name” includes one or a plurality of “areas”, each of which includes one or a plurality of “middle items”. The “middle item” includes one or a plurality of “small items”.

Table 3 shows an example of a check list included in the check list 105a.

TABLE 3

| Job | | | | | | | |
|---|---|---|---|---|---|---|---|
| class. | Class. | | Middle | | | Laws/ | |
| code | name | Area | item | Small item | Check item | ordinances | Result |
| A01 | Whole | 2. | Securities | No unlawful | Have executives or | Securities | ◯ |
| | | Compliance | Law | use of insider | employees having | Law | |
| | | | | information? | access to sensitive info | | |
| | | | | | engaged in stocks | | |
| | | | | | before announcement? | | |
| | | | Labor | Application for | Has a resigning | Civil Law | ◯ |
| | | | Contracts | resignation | employee made to work | Art. 627 | |
| | | | | processed | against his/her will for | | |
| | | | | properly? | two or more weeks | | |
| | | | | | from the date of | | |
| | | | | | resignation application? | | |
| | | | Intellectual | Have acquired | Have acquired trade | Unfair | ◯ |
| | | | Property | trade secrets | secrets of others by | Competition | |
| | | | | by unlawful | unlawful means | Prevention | |
| | | | | means? | (stealing, fraud)? | Law, Art. 2 | |
| | | | | Have used | Have acquired or used | Unfair | ◯ |
| | | | | trade secrets | trade secrets knowing | Competition | |
| | | | | acquired by | that they have been | Prevention | |
| | | | | unlawful | acquired by unlawful | Law, Art. 2 | |
| | | | | means? | means? | | |
| | | 3. Risk | Risk in | Signature | Contracts signed or | Civil Law, | ◯ |
| | | management | Transactions | and seal | sealed by legitimate | Commercial | |
| | | | and Contracts | proper and | representative of the | Law | |
| | | | | correct? | other party? | | |
| | | | | Contract terms | Review by a lawyer or | | Δ |
| | | | | properly | legal dept. conducted | | |
| | | | | examined? | when necessary? | | |
| S01 | | 2. | | . . . | . . . | . . . | ◯ |
| | | Compliance | . . . | . . . | . . . | . . . | Δ |
| . . . | . . . | . . . | . . . | . . . | . . . | . . . | . . . |

The check list includes fields of “job classification code”, “classification name”, “area”, “middle item”, “small item”, “check item”, “related laws and ordinances” and “check result”. The check list is prepared for each department and includes the description of check items to be checked for the particular department. The check list 105a is distributed to a manager of the corresponding department thereto. The manager checks the check result column in accordance with the check items. The mark “◯” may be entered by the reviewing manager, for example, when the check items are completely satisfied. A mark “Δ” may be entered when the check items are satisfied to some degree but not completely. A mark “x” may be entered when the check items are not satisfied. These check results are input to the management diagnosis report preparation system and stored as included in the check list 105a. These results are used for the report preparation process described below. It should be noted that the same “check item” may be included in the check lists of a plurality of departments. The check item “Has a resigning employee made to work against his/her will for two or more weeks from the date of resignation application?”, for example, relates to all the departments and therefore it is included in the check lists of all the departments.

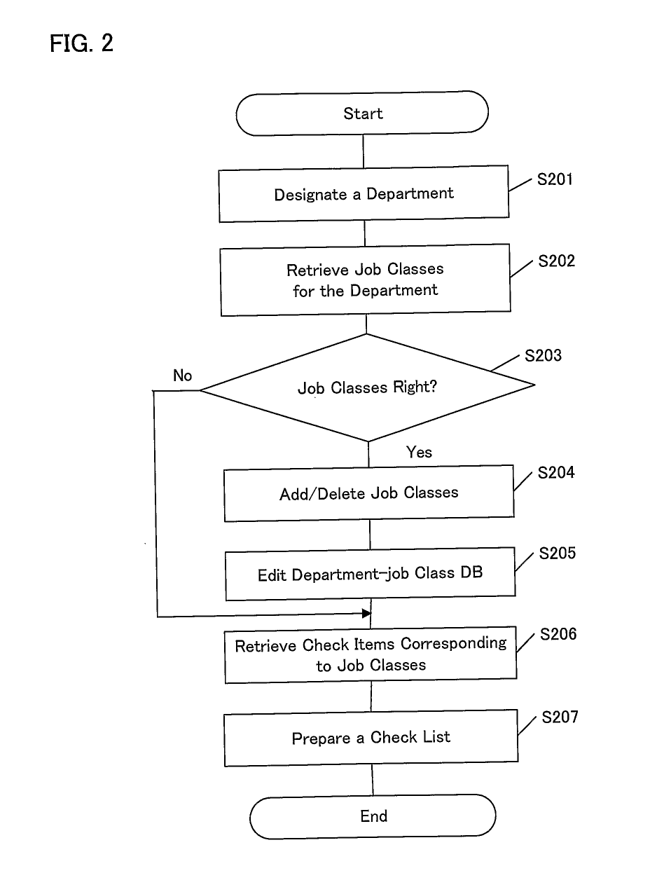

FIG. 2 is a flowchart for describing a process for preparing a check list for each department. The check list 105a can be prepared in the following manner. First, the department name is entered through the input unit 102 (S201). Based on the entered department name, the processor 101 retrieves and extracts the job classifications relevant to the department from the department and job classification DB 105e (S202). Upon retrieval of the job classification, the retrieved classifications are displayed on the display unit 103. Determination may be made whether job classifications are right, that is, whether certain classifications are missing or certain classifications are not necessary (S203). As appropriate, job classifications may be added or deleted via the input unit 102 (S204). Thus, the department and job classification DB is edited (S205). The processor 101 retrieves check items related to the job classifications retrieved from the job classification and check item DB 105d (S206). Using the retrieved check items and the “area”, “middle item”, “small item” and “related laws and ordinances” related thereto, the check list 105a (Table 3) for each department is created (S207).

Tables 4-1 and 4-2 show an example of the data items field names) of the supervisory department and check item DB 105g.

TABLE 4-1

| Supervisory | Job | | Middle | | | Laws/ |
|---|---|---|---|---|---|---|
| Dept. | Class. | Area | item | Small item | Check item | ordinances |
| Personnel | M21 | 2. | Laws | Lawful | Working conditions | Job Sec. Law, |
| Dept. | | Compliance | on labor | recruiting | described in document | Minimum Wage |
| | | | contract | activities? | provided to prospective | Law, Labor |
| | | | | | employees lawful and | Std. Law, Temp. |
| | | | | | proper? | psnl Law |
| Personnel | M21 | 2. | Laws | Checking of a | Government guidance | Constitution |
| Dept. | | Compliance | on labor | job applicant | observed (e.g., no | Art. 13, Labor |
| | | | contract | lawful? | personal inv. permitted | Standard Law, |
| | | | | | for high-school | Civil Law, Art. |
| | | | | | graduates before joining | 90, 709 |
| | | | | | the company)? | |
| Personnel | M21 | 2. | Laws | No | Employment made or | Equal Oppor. |
| Dept. | | Compliance | on labor | discrimination | working conditions | Law, Art. 5, |
| | | | contract | at employment? | differentiated based on | Labor Uni. Law, |
| | | | | | gender, | Art. 7 |
| | | | | | labor-union-activities? | |
| . . . | . . . | . . . | . . . | . . . | . . . | . . . |
| Personnel | M21 | 2. | Labor | Respected labor | Implied to disapprove | Labor Uni. Law, |
| Dept. | | Compliance | Union | union as a | and disrespect labor | Art. 1, 7, Para. |
| | | | Law | party to | union (negative view or | 3, Cons. Art. |
| | | | | negotiate? | ill feeling to labor | 28, case laws |
| | | | | | union)? | |
| Personnel | M21 | 2. | Labor | Properly | Not refused to negotiate | Labor Union Law, |
| Dept. | | Compliance | Union | negotiated with | with a minority labor | Art. 2, 7, Para. |
| | | | Law | each labor | union split from a major | 2 |
| | | | | union when a | labor union? | |
| | | | | union has split? | | |
| . . . | . . . | . . . | . . . | . . . | . . . | . . . |

TABLE 4-2

| Supervisory | Job | | Middle | | | Laws/ |
|---|---|---|---|---|---|---|
| Dept. | Class. | Area | item | Small item | Check item | ordinances |
| General | M01 | 3. Risk | Risk in | Company seal | Procedure for signature | Civil Law, |
| Affairs | | manage- | Contracts | properly | and stamping seals of | Commercial |
| Dept. | | ment | | managed? | corporate representative | Law |
| | | | | | properly managed? | |
| General | M31 | 3. Risk | Risk of | Company cars | Permission given to | Automobile |
| Affairs | | manage- | Traffic | properly | Employees permitted to | Liability |
| Dept. | | ment | Accident | managed? | use company car after | Securities |
| | | | | | checking the purpose, | Law |
| | | | | | method and specifics of | |
| | | | | | license and health of | |
| | | | | | driver? | |
| Legal | A01 | 3. Risk | Risk in | Signature and | Contract signed and | Civil Law, |
| Affairs | | manage- | Contracts | seal properly | sealed by legitimate | Commercial |
| Dept. | | ment | | used? | representative of other | Law |
| | | | | | party? | |
| . . . | . . . | . . . | . . . | . . . | . . . | . . . |

The supervisory department and check item DB 105g is a database in which the “supervisory department” that manages the check items mainly and the “check item” are related to each other. As shown in Table 4-1,4-2, the supervisory department and check item DB 105g has the fields of “supervisory department”, “job classification” (“job classification code”), “area”, “middle item”, “small item”, “check item” and “related laws and ordinances”, and the horizontally adjoining data are related to each other.

Table 5 shows an example of the data items (field names) of the report history DB 105f and the data thereof.

TABLE 5

| Supervisory | | | | | | |
|---|---|---|---|---|---|---|
| Dept. | Year | Priority | Badness | Theme needing action | Action | Dept. |
| Personnel | 2002 | 6 | 28 | No discrimination on working | Educate middle | Sales |
| Dept. | | | | conditions and employee | management on | Dept. |
| | | | | appraisal based on: nationality, | “employee | |
| | | | | belief, social status, gender, | appraisal sheet” | |
| | | | | labor-union-activities, lawful | | |
| | | | | execution of rights | | |
| | 2002 | 12 | 15 | Collect and analyze signs of | Use external | Service |
| | | | | overseas dispute | risk consultant | Dept. |
| | | | | | to acquire and | |
| | | | | | analyze latest | |
| | | | | | information | |
| | | . . . | | . . . | . . . | . . . |
| General | 2002 | 3 | 35 | Executives and employees | Enhance | Intellectual |
| Affairs | | | | having access to sensitive info | “guideline on | property |
| Dept. | | | | prohibited from dealing stocks | insider | |
| | | | | before announce | transaction” | |
| . . . | | . . . | | . . . | . . . | . . . |

The report history DB 105f is a database which stores the diagnosis result (report) having been prepared by the report preparation system before. Specifically, this database stores, as related to each other, “year” when the report has been prepared, “theme needing action” by the “supervisory department”, the past “badness value” for the themes needing action, the “action” for achieving the themes needing action, the “department to be acted” and the “priority of actions”. According to this embodiment, the supervisory department manages a plurality of departments and also a plurality of themes needing action. As described below, the evaluated values are increased or decreased for each action of the action precedent DB 105b using the report history DB 105f.

Table 6 shows an example of the data items (field names) of the report history DB 105f and the data thereof according to another embodiment.

TABLE 6

| Dept. | | | | | |
|---|---|---|---|---|---|
| code | Dept. | Year | Area | Theme needing action | Action |
| 10-02 | Sales | 2002 | 2. | Executives and employees | Enhance “guideline to |
| | Div., | | Compliance | having access to sensitive | insider transaction” |
| | Sales | | | info prohibited from dealing | |
| | Dept. | | | stocks before announcement | |
| | | | | Trade secrets not to be | Prohibit acquisition or |
| | | | | acquired or used knowingly | use of trade secrets by |
| | | | | by unlawful means | unlawful means |
| | | | 3. Risk | Contract to be signed and | Have contract signed and |
| | | | Management | sealed by legitimate rep. of | sealed by legitimate rep. |
| | | | | the other party | of the other party |
| 10-01 | Sales | 2002 | 2. | at sales visit, document on | at sales visit, when |
| | Div., | | Compliance | specifics of commodity | customer agrees to buy, |
| | Sales | | | purchase to be promptly | provide document on |
| | Dev. | | | provided to customer | specifics of commodity |
| | Dept. | | | when the customer is | promptly |
| | | | | interested in purchase | |
| . . . | | . . . | | . . . | . . . |

The report history DB 105f is a database which stores the report results of the past having been prepared by the report preparation system. The report history DB 105f has the fields of “department code”, “department name”, “year”, “area”, “theme needing action” and “action”, and the horizontally adjoining pieces of data are related to each other. Specifically, as shown in Table 6, the “actions” set for achieving the “themes needing action” charged on the “department” during the last year (assumed to be 2002 in this case) are stored as related to each other. According to this embodiment, the report history database only for last year is used. Nevertheless, the report history DB 105f storing the report results for a plurality of years may be used. As described below, by accessing the report history DB 105f, the evaluated value for each of the “actions” in the action precedent DB 105b are increased or decreased.

Tables 7-1 and 7-1 show an example of the data item names (field names) of the action precedent DB 105b.

TABLE 7-1

| | | Evaluated |
|---|---|---|
| Theme needing action | Action | Value |
| Executives and employees having | Prohibit executives and employees having | 3 |
| access to sensitive info prohibited | access to sensitive info from dealing stocks | |
| from dealing stocks before | before announcement | |
| announcement | Enhance “guideline to insider transaction” | 6 |
| Resigning employee not required to | Prohibit a resigning employee from | 3 |
| work against his/her will for two or | continuing to work against his/her will for | |
| more weeks from the date of | two or more weeks from the date of | |
| resignation application | resignation application | |
| Working conditions and employee | Eliminate discriminatory working | 6 |
| appraisal not to be discriminatory | conditions and employee appraisal based | |
| based on: nationality, belief, social | on: nationality, belief, social status, gender, | |
| status, gender, | labor-union-activities, legitimate execution | |
| labor-union-activities, legitimate | of rights | |
| execution of the rights | Educate middle management about | 2 |
| | “employee appraisal sheet” | |
| Management required to guide | Supervise managers so that no employees | 4 |
| and supervise the employees not to | work overtime without pay | |
| work overtime without pay | | |
| Illegal software duplication | Prohibit illegal software duplication | 4 |
| required to be prohibited | | |
| Do not acquire trade secrets of | Prohibit acquisition of trade secrets of | 3 |
| others by unlawful means such as | others by unlawful means such as by | |
| by stealing or fraud | stealing or fraud | |

TABLE 7-2

| | | Evaluated |
|---|---|---|
| Theme needing action | Action | Value |
| To prohibit acquisition and use of | Prohibit acquisition and use of trade | 6 |
| trade secret knowing that they | secrets knowing that they have been | |
| have been acquired by unlawful | acquired by unlawful means | |
| means | | |
| Contracts required to be signed | Contracts to be signed and sealed by | 3 |
| and sealed by legitimate rep. of | legitimate rep. of the other party | |
| the other party | | |
| To have reviewed by lawyer or | Request review by lawyer or legal dept. if | 5 |
| legal dept. if necessary | necessary | |
| To disclose name, company | Disclose name, company name, type of | 4 |
| name, type of commodity and | commodity and right to sell the commodity | |
| right to sell the commodity to | to customers at sales visit | |
| customers at sales visit | | |
| at sales visit, document on | at sales visit, provide document on specifics | 2 |
| specifics of commodity purchase | of commodity purchase promptly when the | |
| to be promptly provided to | customer is interested in purchase | |
| customer when the customer is | Thoroughly instruct staff in charge to | 5 |
| interested in purchase | follow “sales staff manual” again | |
| Not to cause undue delay or | Prohibit undue refusal and delay of | 4 |
| cancellation of purchase contract | execution of purchase contract and service | |
| or service agreement signed at | agreement signed at sales visit | |
| sales visit | | |

The action precedent DB 105b is a database to store cases of the actions for achieving the themes for the supervisory department. One or a plurality of “actions” are related to the “theme needing action”. Also, the “evaluated value” can be given to each “action”. The evaluated values indicate the degree of effectiveness of a particular action.

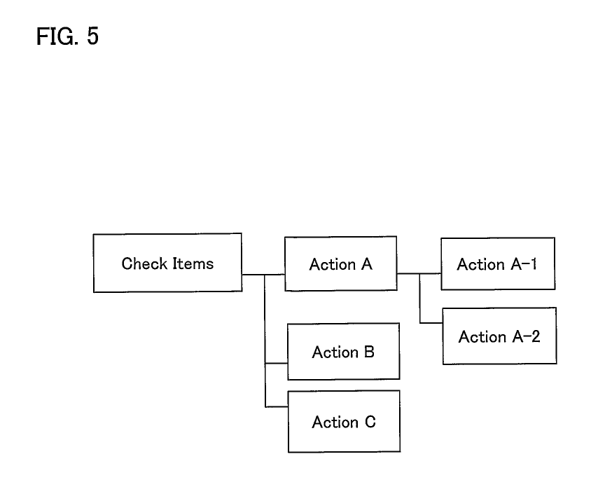

The “actions” included in the action precedent DB 105b may be presented in a tree structure including the super-ordinate concept and the subordinate concept, as shown in FIG. 5. At the same time that the evaluation values (points) may be given to a subordinate action, the evaluation values may be given to a superordinate action. In the case where the evaluation values are given to “action A-1”, for example, the evaluation values are also given to the generic action, i.e. “action A”. Further, in extracting a action of highest evaluation value in the presence of a subordinate action, the particular subordinate actions may be displayed to permit selection.

Tables 8-1 and 8-2 show the conversion from “check item” to “theme needing action”.

TABLE 8-1
Check item

Have executives or employees having access to
sensitive info dealt stocks before announcement?
Has a resigning employee made to work against
his/her will for two or more weeks from the date of
resignation application?
Have acquired trade secrets of others (confidential
information on techniques or sales useful for
business activities) by unlawful means such as by
stealing or fraud?
. . .

TABLE 8-2
Theme needing action

Executives and employees having access to sensitive info
prohibited from dealing stocks before announcement
Resigning employee not required to work against his/her will
for two or more weeks from the date of resignation application
Do not acquire trade secrets of others (confidential information
on techniques or sales useful for business activities), such as by
stealing or fraud
. . .

The “theme needing action”, one of the fields used in this embodiment, can be prepared automatically based on the character string data of “check item” prepared earlier. As shown in Tables 8-1 and 8-2, for example, the characters such as “done?”, “let it done?”, “doing?” and “Have . . . done?” are converted to the characters such as “required not to be done”, “required not to let it be done”, “required not to do” and “. . . not required to do”. Specifically, the part of the phrase of the check item is converted into an appropriate expression for the “theme needing action”. In a specific method, the character string “Have . . . done?” is related to the character string “not required to do” and stored in the storage unit 105 as a phrase end conversion database (not shown). The processor 101 searches the character strings to determine whether the part of the phrase has the character string “Have . . . done?” for all the “check items”. Upon discovery of a corresponding character string, the corresponding part of the phrase is replaced with the part of the phrase “not required to do”, and thus related to the “check item” as the “theme needing action”. The resulting character string is stored as a check item and theme DB (not shown).

Table 9 shows an example of the diagnosis result output by the management diagnosis report preparation system.

TABLE 9

| Pri- | | | |
|---|---|---|---|
| ority | Theme needing action | Action | Dept |
| | Resigning employee not | Educate middle | Sales |
| | required to work against | management on rules of | Dept. |
| | his/her will for two or | employment again | |
| | more weeks from the date | | |
| | of resignation application | | |
| 6 | No discrimination on | Eliminate discriminatory | Sales |
| | working conditions and | working conditions and | Dev. |
| | employee appraisal based | employee appraisal based | Section |
| | on: nationality, belief, | on: nationality, belief, | |
| | social status, gender, | social status, gender, | |
| | labor-union-activities, | labor-union-activities, | |
| | lawful execution of | legitimate execution of | |
| | rights | rights | |
| 7 | Management required to | Educate middle | Service |
| | guide and supervise the | management again on | Dept. |
| | employees not to work | labor agreement and | |
| | overtime without pay | rules of employment | |
| 12 | Collect and analyze | Use external risk | Intel- |
| | signs of overseas | consultant to acquire | lectual |
| | dispute | and analyze latest | Property |
| | | information | Dept. |

By the diagnosis process described below, the “theme needing action” charged on the “supervisory department”, the “action” therefore, the department to be acted and the “priority of actions” are output in table form. This output result is stored in the report history DB 105f with the horizontal data related to each other, as described above.

The department fundamentals DB 105c is a database which stores the basic information on each department and stored in the storage unit 105 like other databases. The basic information includes the name of the divisions, the name of the divisions manager and the name of the department manager related to each department.

2. Execution Process

### First Embodiment

A report preparation process for a report preparation system according to an embodiment of the present invention will be explained.

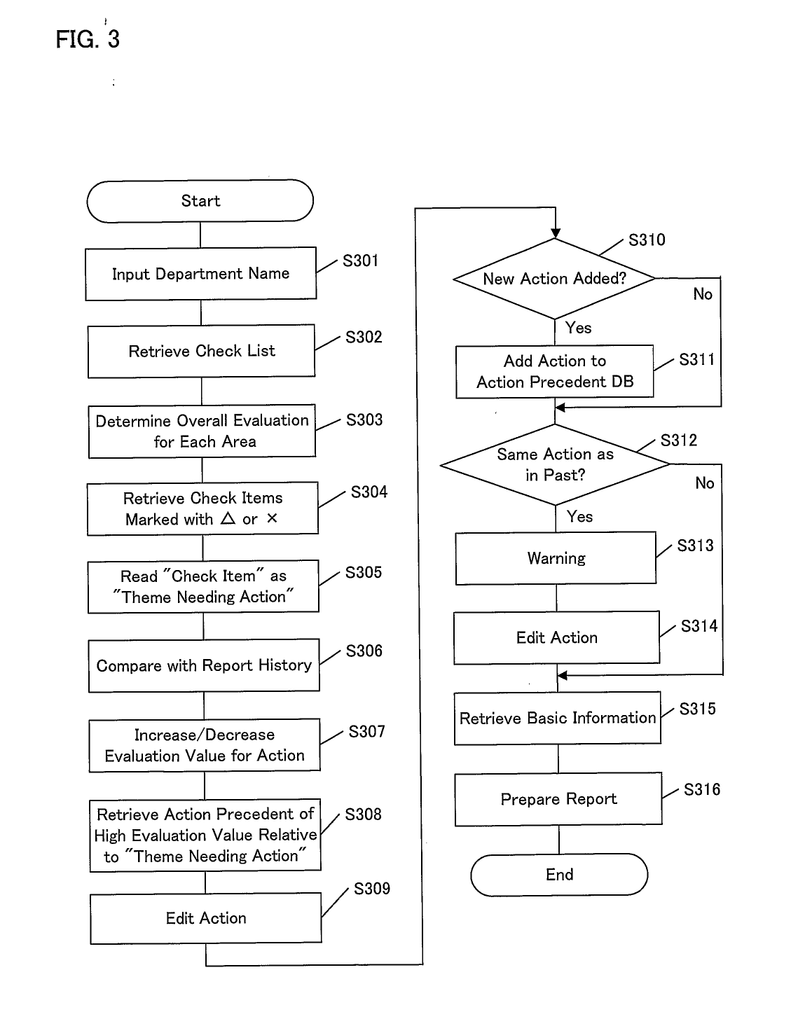

FIG. 3 is a flowchart for explaining the report preparation process carried out by the report preparation system. First, the name of the department for which the report is to be prepared is input through the input unit 102 (S301). Once the department name is input, the processor 101 retrieves a check list corresponding to the input department name from the check list DB 105a (S302). Next, the processor 101 totalizes the check results included in the retrieved check list for each area of governance, compliance, risk management and corporate moral, and makes the overall evaluation to be carried in the report for each area (S303). The overall evaluation is conducted in three stages of A, B and C. The evaluation is made by the processor 101 for each area in such a manner that C is given in the case where at least one item is “x”, A in the case where “◯” represents two thirds or more, and B in the other cases.

Next, the processor 101 identifies all the check items (improvement-required items) carrying “Δ” or “x” (badess indications of the check result indications) from the check result of the retrieved check list (S304). Subsequently, all the “themes needing action” related to the “check items” thus identified are retrieved by accessing the check item and theme DB (S305).

Next, the processor 101 makes a comparison with the report history (S306). At S306, the processor 101 retrieves all the “themes needing action” in the report of last year for the input department, and then makes comparison to determine whether each of the “themes needing action” included in the report is identical with the “theme needing action” retrieved at S305. The identification can be conducted from the identity of the character strings. As an alternative, however, a unique search code is given to each data and the identity can be made with the search code as a key.

Next, the evaluation values (evaluation value) are increased or decreased based on the result of comparison at S306 (S307). Specifically, the processor 101 compares the “theme needing action” in the report for last year with the “theme needing action” retrieved at S305, and in the presence of an identical “theme needing action” (i.e. in the case where the theme is not yet improved), reduces the evaluation value of the “action” for achieving the “theme needing action” in the report of last year by 1. Also, in the case where the comparison shows that the report of last year has no “theme needing action” identical with the “theme needing action” retrieved at S305 (i.e. in the case where the theme has been improved), the processor 101 increases the evaluation value of the “action” for achieving the “theme needing action” in the report of last year by 1. In this way, each time the report preparation process is executed, the evaluation values are increased or decreased for the “action” stored in the action precedent DB 105b.

Next, the processor 101 retrieves, from the action case DB 105b, the action of highest evaluation value for achieving the “theme needing action” related to the “check item” regarded as an improvement required item at S302 (S308). In Table 7, assume that the theme needing action is, for example, “Executives and employees having access to sensitive info prohibited from dealing stocks before announcement”. The action “Enhance “guideline to insider transaction”” more thoroughly” has 6 points, while the action “Prohibit executives and employees having access to sensitive info from dealing stocks before announcement”=0 stands at 3 points. Thus, the processor 101 retrieves the action “Enhance “guideline to insider transaction”” having high points as a “action” to be carried in the report. As an alternative, the department information associated with the action stored in the action precedent DB is stored in the particular action, and the job classification is compared for each department using the department and job classification DB. In this way, the actions of the departments having a similar job classification may be retrieved. Thus, the actions for achieving the themes needing action for the improvement-required items are retrieved for all the four areas.

Next, in order that the person in charge of each department may correct the retrieved “action” in accordance with the style of his department or can select other actions from the action precedent DB 105b, the processor 101 can display the editing screen for correcting the retrieved actions on the display unit 103 (S309). In the case where the correction is to add a new action (S310), the processor 101 adds the particular action to the action precedent DB 105b as related to the “theme needing action” (S311).

The processor 101 determines by comparison whether the “action” for achieving the “theme needing action” retrieved at S305 and S308 is identical with each of the “actions” for achieving the “theme needing action” included in the report of last year stored in the report history DB 105f (Table 5) (S312). In the case where the “action” for achieving the “theme needing action” retrieved currently is identical with the “action” for achieving the “theme needing action” included in the report of last year, it indicates that the theme of last year has yet to be improved and the action therefore is not effective. Therefore, the processor 101 can display the warning information on the display unit 103 (S313). This warning can be issued in the form of a print on the output unit 104. Subsequently, the processor 101 can display the editing screen on the display unit 103 to allow the “action” to be edited again through the input unit 102.

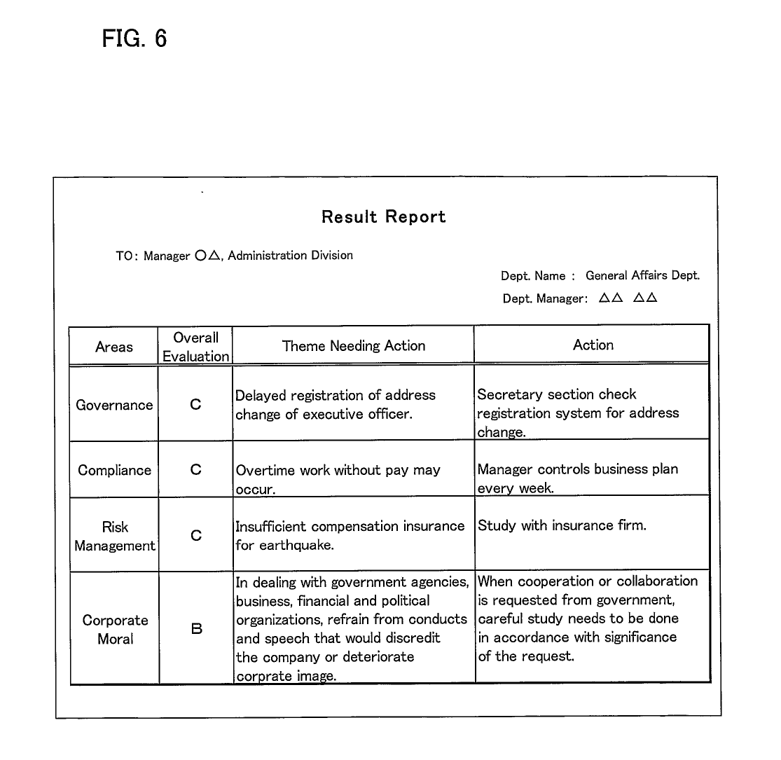

The processor 101 retrieves the name of the divisions, the name of the divisions manager and the name of the department manager which are related to the input department name from the department fundamentals DB 105c (S315). The processor 101 prepares the report shown in FIG. 6 by fitting the retrieved divisions name, area, evaluation, theme needing action and action in a predetermined template (S316). The report may be displayed on the display unit 103 or printed through the output unit 104. In this way, the actions each related to with the evaluated values are evaluated based on the past report result. Based on this evaluation, an effective action can be retrieved, and therefore, a report including an effective action can be prepared.

Finally, the processor 101 stores, in the report history DB 105f, the department name, the area, the theme needing action and the effectiveness which have been retrieved by the aforementioned process, as related to the current year. The report for the current year is thus made ready for utilization to execute this process for the next year, and then the process is ended.

### Second Embodiment

Next, a report preparation process in a report preparation system according to another embodiment of the present invention will be explained.

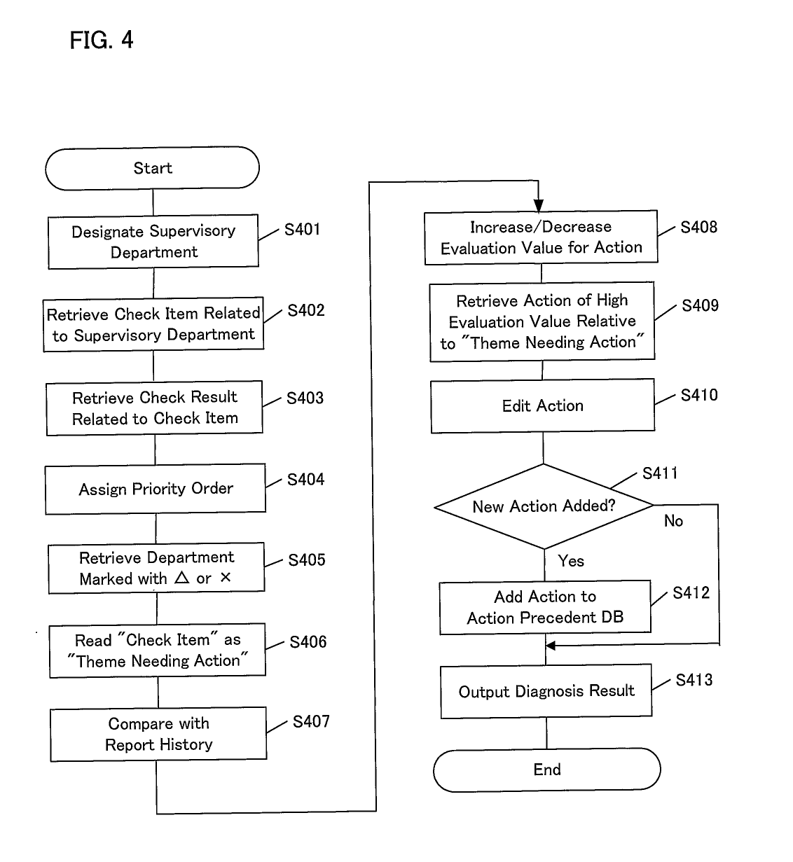

FIG. 4 is a flowchart for explaining the report preparation process carried out by the report preparation system. First, the name of the supervisory department to output the diagnosis result is input through the input unit 102 (S401). Once the supervisory department name is input, the processor 101 searches the supervisory department and check item DB 105g to identify all the “check items” related to the input supervisory department (i.e. the check items managed mainly by the input supervisory department) (S402).

Once the check items are identified, the processor 101 searches the check list 105a and identifies all the check results related to the identified “check items” (S403).

The processor 101 totalizes the identified check results for each check item, and assigns priority order to each check item (S404). In a specific method of assigning the priority order, assume that the mark “x” represents 2 points, “Δ” 1 point and “◯” 0 point, and the check results given by all the departments are totalized for each check item, and the totalization result for each check item is used as the badness values. The priority order is given to the “check items” in the descending order of the badness values. Thus, the check item having more marks “x” or “Δ” is assigned a higher order of priority.

Next, the processor 101, with reference to the check list 105a, identifies the department carrying the mark “Δ” or “x” (badness indications) on the “result” in the check list checked currently by each department (S405). The processor 101, with reference to the check item and theme DB, identifies the “theme needing action” related to each check item carrying the badness indication of the check result indication (S406).

Once the theme needing action is identified, the processor 101 compares, for each theme needing action, the badness values included in the diagnosis result (report) for last year in the report history DB with the badness values identified at S404 (S407) and increases or decreases the evaluation value given to each action stored in the action precedent DB 105b (S408).

The evaluation values are increased or decreased in the following manner. The processor 101, with reference to the diagnosis result (report) for last year (2002 in this case) in the report history DB 105f (Table 6) of the input supervisory department, compares the badness values for each theme needing action identified at S406 for each supervisory department. Next, the processor 101 increases or decreases the evaluation values by determining whether the badness values are higher than the badness values currently totalized at S404 for each theme needing action. In the case where the current badness values are higher, the action for the last year is considered not effective, and therefore, the processor 101 decreases the evaluation values for the action related to the theme needing action (i.e. the check items) in the report of last year by 1. In the case where the current badness values are lower, on the other hand, the action taken last year is considered effective, and the processor 101 adds 1 to the evaluation values for the action related to the theme needing action in the report for last year. In the case where the badness values are equal, the evaluation values for the action are not increased or decreased. In this way, the evaluation values for each action stored in the action precedent DB 105b are increased or decreased.

Next, the processor 101 retrieves the “action” of highest points out of the “actions” related to the “theme needing action” constituting an improvement-required item from the action precedent DB 105b (S409). In Table 7-1, for example, in the “theme needing action”, “Working conditions and employee appraisal not to be discriminatory based on: nationality, belief, social status, gender, labor-union-activities, legitimate execution of the rights” is related to 6 points for “Eliminate discriminatory working conditions and employee appraisal based on: nationality, belief, social status, gender, labor-union-activities, legitimate execution of rights” and 2 points for “Educate middle management about “employee appraisal sheet””. The former is higher in points than the latter. The processor 101, therefore, selects “Eliminate discriminatory working conditions and employee appraisal based on: nationality, belief, social status, gender, labor-union-activities, legitimate execution of rights”. In this way, all effective “actions” are retrieved for the check items constituting the improvement-required items of the supervisory department input.

In order to allow a person belonging to the supervisory department to correct the “action” retrieved through the input unit 102 or select other actions from the action precedent DB 105b, the processor 101 can display an editing screen on the display unit 103 to correct the action retrieved (S410). In the case where the correction is to add a new action (S411), the processor 101 adds the particular action to the action precedent DB 105b as related to the “theme needing action” (S412).

Upon completion of the process described above, the processor 101 fits the priority order identified at S404, the retrieved theme needing action, action and department to be acted in a predetermined template, and prepares the diagnosis result (report) shown in Table 9 (S413). The diagnosis result may be displayed on the display unit 103 or printed through the output unit 104. In this way, the evaluation values are given to the action, which is thus evaluated based on the past check result. An effective action can thus be retrieved based on the evaluation values, and therefore the diagnosis result including an effective action can be prepared.

Once the diagnosis result is prepared, the processor 101 stores the diagnosis result in the report history DB 105 as related to the year of preparation. By doing so, in the next year, the “action” can be evaluated based on the diagnosis result.

1-10. (canceled)

11. A system for preparing a report containing actions for achieving one or more themes, comprising:
a first database for storing one or more check items for reviewing achievement of each theme, one or more check result indications given to respective check items by an acting department, a plurality of actions for achieving said one or more themes, and evaluation values given to respective actions indicating the degree of effectiveness of respective actions;
a second database for storing past reports containing past themes and the actions used for achieving the past themes; and
a computer for preparing the report, the computer being programmed to,
compare the theme corresponding to a check item to which an badness indication has been given by the current review with a theme contained in the past reports, and if they match, decrease the evaluation value of the action for achieving the matched theme, and if no match is made, increase the evaluation value of the action for achieving the theme contained in the past reports;
select from said first database an action having a high evaluation value among all the actions that relate to check items carrying check result indications needing actions; and
prepare a current report containing one or more selected actions and one or more themes corresponding to a check item carrying a check result indication needing action.

12. A system according to claim 11, further comprising:
a third database for storing one or more identifications of acting departments that have evaluated the check items; and
an input device for inputting an identification of an acting department,
wherein the computer is programmed to prepare a current report containing the themes corresponding to the check items reviewed by the acting department.

13. A system for preparing a report containing actions for achieving one or more themes, comprising:
a first database for storing one or more check items for reviewing achievement of each theme, one or more check result indications given to respective check items by an acting department, a plurality of actions for achieving said one or more themes, and evaluation values given to respective actions indicating the degree of effectiveness of respective actions;
a second database for storing past reports containing past themes and the actions used for achieving the past themes, said second database further storing one or more past badness values with respect to respective themes; and
a computer for preparing the report, the computer being programmed to,
determine badness values for a theme based on the number of check result indications given to the check item in the current review;
compare the current badness value with corresponding past badness value;
increase the evaluation value of the action for achieving the past theme if the current badness value is smaller than the past badness value;
decrease the evaluation value of the action for achieving the past theme if the current badness value is larger than the past badness value
select an action having a high evaluation value among all the actions that relate to check items carrying check result indications needing actions; and
prepare a current report containing one or more selected actions and one or more themes corresponding to a check item carrying a check result indication needing action.

14. A system according to claim 13, further comprising:
a third database for storing one or more identifications of supervisory departments for managing check items; and
an input device for inputting the supervisory department,
wherein the computer is programmed to prepare a current report containing one or more themes relating to the check items managed by the supervisory department, said themes selected from the themes corresponding to the check items carrying badness indications.

15. A computer implemented method for preparing a report containing actions for achieving one or more themes, comprising:
storing in a first database one or more check items for reviewing achievement of each theme, one or more check result indications given to respective check items by an acting department, a plurality of actions for achieving said one or more themes, and evaluation values given to respective actions indicating the degree of effectiveness of respective actions;
storing in a second database past reports containing past themes and the actions used for achieving the past themes; and
comparing the theme corresponding to a check item to which an badness indication has been given by the current review with a theme contained in the past reports, and if they match, decrease the evaluation value of the action for achieving the matched theme, and if no match is made, increase the evaluation value of the action for achieving the theme contained in the past reports;
select from said first database an action having a high evaluation value among all the actions that relate to check items carrying check result indications needing actions; and
preparing a current report containing one or more selected actions and one or more themes corresponding to a check item carrying a check result indication needing action.

16. A method according to claim 15, further comprising;
storing in a third database one or more identifications of acting departments that have evaluated the check items; and
responsive to entry of identification of an acting department, preparing a current report containing the themes corresponding to the check items reviewed by the acting department.

17. A computer implemented method for preparing a report containing actions for achieving one or more themes, comprising:
storing in a first database one or more check items for reviewing achievement of each theme, one or more check result indications given to respective check items by an acting department, a plurality of actions for achieving said one or more themes, and evaluation values given to respective actions indicating the degree of effectiveness of respective actions;
storing a second database past reports containing past themes, the actions used for achieving the past themes, and one or more past badness values with respect to respective themes,
determining badness values for a theme based on the number of check result indications given to the check item in the current review;
comparing the current badness value with corresponding past badness value;
increasing the evaluation value of the action for achieving the past theme if the current badness value is smaller than the past badness value; and
decreasing the evaluation value of the action for achieving the past theme if the current badness value is larger than the past badness value;
selecting an action having a high evaluation value among all the actions related to the check items carrying the check result indications needing actions; and preparing a current report containing one or more selected actions and one or more themes corresponding to a check item carrying a check result indication needing action.

18. A method according to claim 17, further comprising:
storing one or more identifications of acting departments that have evaluated the check items; and
responsive to entry of an identification of an acting department, preparing a current report containing the themes corresponding to the check items reviewed by the acting department.
